(19) United States
(12) Patent Application Publication
(10) Pub. No.: US 2011/0269020 A1
(43) Pub. Date: Nov. 3, 2011

(54) ELECTROCHEMICAL ELEMENT ELECTRODE PRODUCING METHOD, ELECTROCHEMICAL ELEMENT ELECTRODE, AND ELECTROCHEMICAL ELEMENT

(76) Inventors: Yuma Kamiyama, Osaka (JP); Kazuyoshi Honda, Osaka (JP); Yasuharu Shinokawa, Osaka (JP); Tomofumi Yanagi, Osaka (JP)

(21) Appl. No.: 13/143,123

(22) PCT Filed: Jan. 7, 2010
(86) PCT No.: PCT/JP2010/000063

§ 371 Date: Jul. 1, 2011

(30) Foreign Application Priority Data
Jan. 7, 2009 (JP) 2009-001882 2009

(51) Int. Cl. H01M 4/134; B32B 3/00; H01G 4/06; C23C 28/00; B32B 38/10; H01M 4/1395; B05D 5/12

(52) U.S. Cl. 429/218.1; 428/141; 427/77; 205/183; 156/247; 361/321.1

(57) ABSTRACT

Provided is a method for easily and surely removing projections formed on the surface of an active material layer by a vacuum process when producing an electrochemical element electrode. Carried out to produce the electrochemical element electrode are: a first step of forming an active material layer on a current collector by a vacuum process, the active material layer being capable of storing and emitting lithium; a second step of storing the lithium in the active material layer; and a third step of removing projections on the surface of the active material layer storing the lithium.

### TECHNICAL FIELD

The present invention relates to a method for producing an electrochemical element electrode usable in lithium secondary batteries and electrochemical capacitors, an electrochemical element electrode, and an electrochemical element.

### BACKGROUND ART

In recent years, mobile devices have been reduced in size and increased in functionality, and accordingly, it has been desired to increase the capacities of batteries as power supplies of such mobile devices. A theoretical capacity of carbon currently mainly used as a negative-electrode active material is 372 mAh/g. As an active material which is higher in capacity than carbon, silicon having the theoretical capacity of 4,200 mAh/g is regarded as promising. Therefore, a large number of electrode materials each containing silicon as a major component and a large number of structures of the electrode materials each containing silicon as a major component have been studied.

One of them is an active material layer formed on a current collector as a layer containing silicon as a major component. Vacuum processes, such as vacuum deposition, have been studied as a method for forming this active material layer.

Meanwhile, to produce electrodes of lithium batteries with high productivity, there is a method for forming the active material layer on an elongated current collector foil from when the foil is pulled out from a roll until when it is taken up by another roll, which is a so-called roll-to-roll method. In this method, the elongated current collector foil winding around one roll is attached to a pull-out device provided at an upstream portion of a film forming route of the active material layer, and another roll is attached to a take-up device provided at a downstream portion of the film forming route. Next, the active material layer is formed on the pulled-out current collector foil, and the obtained electrode is taken up by the roll attached to the take-up device.

In the case of combining the roll-to-roll method and the vacuum deposition as the vacuum process, bumping of deposition materials occur, and projections are formed on the surface of the electrode.

The bumping of the deposition materials is a phenomenon in which the deposition materials in a crucible does not vaporize but are emitted as liquids or solids. If the materials emitted by the bumping hit the current collector foil and the active material layer, unwanted projections are formed thereon. It is thought that the bumping of the deposition materials occurs due to impurities contained in the deposition materials in the crucible or temperature irregularity in the crucible. It is possible to reduce the bumping, but it is difficult to eliminate the bumping. Especially when the film formation is carried out for a long period of time while supplying deposition materials, it is difficult to eliminate the bumping.

In a case where a battery is produced by using an electrode having the projections, and the heights of the projections on the surface of the electrode are greater than the thickness of the separator (about 20 μm in thickness), the projections may penetrate the separator, and internal short-circuit between a positive electrode and a negative electrode may occur. Therefore, before producing the battery, it is necessary to remove the projections having the heights equal to or greater than the thickness of the separator.

Proposed as a method for removing the projections on the surface of the electrode is a method for removing the projections by rubbing the electrode with a wiping cloth and suctioning the removed materials (see PTL 1, for example).

Moreover, disclosed as a method for removing the projections adhered to the electrode produced by the vacuum process are a method for detecting the projections on the surface of the electrode and making through holes on a polar plate (see PTL 2) and a method for crushing the projections by application of pressure (see PTL 3).

### CITATION LIST

### Patent Literature

PTL 1: Japanese Laid-Open Patent Application Publication No. 11-347504
PTL 2: Japanese Laid-Open Patent Application Publication No. 2006-277956
PTL 3: Japanese Laid-Open Patent Application Publication No. 2006-278170

### SUMMARY OF INVENTION

### Technical Problem

As the method for removing the projections before taking up the electrode, the method of PTL 1 for rubbing the surface of the electrode with the wiping cloth is effective for an electrode of a paste application type. However, the projections formed by the bumping of the deposition materials in the vacuum deposition are harder than the projections on the electrode of the paste application type, and binding force between the projection and the current collector foil or between the projection and the active material layer is high. Therefore, in the case of using the wiping cloth made of a low-strength material, the cloth tears, and the projections cannot be removed. In contrast, in the case of using the wiping cloth made of a high-strength material, the projections which have gotten stuck with the wiping cloth may be removed, but the current collector foil may tear together with the projections.

Each of PTLs 2 and 3 discloses a method for removing the projections formed during the vacuum deposition. PTL 2 discloses the method for removing the projections by detecting the projections with a sensor and making the through holes. However, since the electrode around the through hole cannot be used, this causes a reduction in yield. Further, since this method requires the detection of the projections by the sensor and pinpoint punching, it is difficult to carry out this process at high speed, and production speed may decrease. Moreover, the method of PTL 3 for crushing the projections by application of pressure is a method for reducing the heights of the projections by application of pressure or a method for causing the projections to dent in the current collector, so that the projections are not removed.

Here, an object of the present invention is to provide a method for easily and surely remove the projections on the surface of the active material layer, the projections being formed by the vacuum process when producing the electrochemical element electrode.

### Solution to Problem

To solve the above conventional problems, a method for producing an electrochemical element electrode according to a first aspect of the present invention includes: a first step of forming an active material layer on a current collector by a vacuum process, the active material layer being capable of storing and emitting lithium; a second step of storing the lithium in the active material layer; and a third step of removing projections on a surface of the active material layer storing the lithium.

In the present invention, as the active material layer capable of storing and emitting the lithium, it is preferable to use an active material layer which is formed by an active material capable of storing and emitting lithium and expands (increases in volume) by storing the lithium. From this viewpoint, in the present invention, it is preferable that the active material be formed by silicon, a silicon oxide, an alloy containing silicon, or a compound containing silicon.

The above silicon, silicon oxide, and the like are expected as, for example, a high-capacity negative-electrode active material in a lithium ion secondary battery. It is known that silicon, a silicon oxide, and the like can store a large amount of lithium and expand by storing the lithium.

For example, in the case of using silicon as the negative-electrode active material, the volume of the fully-charged negative-electrode active material becomes about four times the volume of the negative-electrode active material before storing the lithium. Even if the silicon of a silicon oxide negative electrode is oxidized to suppress the charging capacity and the expansion, the volume of the silicon oxide negative electrode becomes two to three times depending on the degree of oxidation.

The projections adhered to the polar plate by the vacuum deposition are called splash particles. The splash particles are formed such that raw material melt and unmelted raw materials in a deposition source fly and adhere to the polar plate by, for example, sudden heating. When storing the lithium in the negative electrode polar plate having the surface to which the projections are adhered by the vacuum deposition, not only the active material layer of the polar plate but also the projections store the lithium.

At a portion, to which the projection is adhered, of the polar plate, the projection adhered to the surface of the portion stores the lithium. Therefore, the lithium does not reach the active material layer immediately under the projection, so that the lithium is not stored in the active material layer immediately under the projection. As a result, an expansion coefficient of the projection and an expansion coefficient of the active material layer become different. With this, an interface between the projection and the active material layer is distorted by the difference between those expansion coefficients, so that the projection is easily removed.

Moreover, in a case where the lithium is stored in the polar plate to which the projections are adhered, peripheral regions to which the projections are not adhered on the active material layer store the lithium and expand. In contrast, regions to which the projections are adhered cannot store the lithium, and the expansion coefficient becomes extremely low. Therefore, at an end portion of the projection, the projection is pushed up by the expanded active material layer, and a stress is applied such that the projection is removed from the unexpanded active material layer immediately under the projection.

According to the above, after the active material layer is formed by the vacuum deposition, the adherence strength of the projection is high, and it is difficult to remove the projection. However, after the lithium is stored, the projections can be easily peeled off.

Moreover, it has been difficult to remove small projections by conventional methods for removing the projections which do not store the lithium. However, since the small projections expand by storing the lithium, they can be easily removed.

To secure the difference between the expansion coefficient of the projection and the expansion coefficient of the active material layer immediately under the projection, it is desirable that in the present invention, the amount of lithium stored before removing the projection be not lower than 10% of a theoretical charging capacity of the active material layer. The more the amount of lithium stored increases, the more the projection expands. This facilitates the removal of the projection. Therefore, the upper limit of the amount of lithium stored may be 100% or lower. However, if the amount of lithium stored is large, the lithium tends to spread to the active material layer immediately under the projection from therearound, and the lithium tends to be deposited on the surface of the polar plate. Therefore, it is preferable that the amount of lithium stored before removing the projections be not higher than 50% of the theoretical charging capacity of the active material layer, and it is further preferable that it be not higher than 30%.

An electrochemical element electrode according to a second aspect of the present invention is an electrochemical element electrode including: a sheet-shaped current collector; and an active material layer supported by the current collector, wherein: the active material layer stores lithium, the amount of which is not lower than 10% and not higher than 100% of a theoretical charging capacity of the active material layer; and minute regions which do not store the lithium exist on a surface of the active material layer.

The electrochemical element electrode can be produced by the producing method according to the first aspect of the present invention. In accordance with the above producing method, at a portion, to which the projection is adhered in the first step, of the surface of the active material layer, the projection store the lithium in the second step, so that the active material layer itself does not store the lithium. Therefore, when the projections are removed in the third step, about 1 to 50 minute regions per square centimeter are formed on the surface of the active material layer in accordance with the shapes of the projections and the number of projections, the minute regions having the average diameter of 10 to 500 μm and not storing the lithium.

The existence of the minute region which does not store the lithium can be confirmed such that the surface of the active material layer is subjected to the analysis of element distribution by, for example, fluorescent X-ray microanalysis. Moreover, the minute region can be confirmed by observing the surface of the active material layer with a laser microscope.

In a case where the electrode from which the projections are removed without storing the lithium as in conventional cases is charged and discharged, the active material layer is charged and discharged substantially uniformly. Therefore, unlike the electrode formed by using the producing method of the present invention, the minute regions which do not store the lithium are not formed.

In the electrode which can be formed by the producing method of the present invention and has the minute regions which do not store the lithium, the expansion behavior of a portion storing the lithium and the expansion behavior of a portion not storing the lithium are different from each other. Therefore, projections and depressions are formed on the surface of the active material layer, and this makes it possible to reduce frictional resistance at the time of feeding the electrode. Further, the active material layer in the minute region which does not store the lithium does not expand as compared to the peripheral region. Therefore, the minute regions form depressions on the surface of the active material layer. On this account, if minute adhering matters remain on the electrode, they tend to get in these depressions. Therefore, in a case where a battery or a capacitor is produced by using this electrode, and the remaining adhering matters further store the lithium to expand during charging or discharging, the internal short-circuit caused by the penetration of the separator by the adhering matters is unlikely to occur as compared to a case where the depressions are not formed.

Moreover, in accordance with the electrode which is produced by the present invention and has the minute regions which do not store the lithium, the depressions exist on the surface of the active material layer, and this increases the surface area. Therefore, an electrolytic solution wetting characteristic of this electrode becomes more excellent than that of a flat electrode which substantially uniformly stores the lithium.

Further, in a case where the active material layer is formed such that a plurality of columnar active materials are arranged on the current collector in the first step of the present invention, the active material layer expands during charging from a column upper portion which tends to store the lithium. Therefore, gaps are filled at the upper portion of the columnar active material layer by the expansion of the active material layer, but gaps comparatively remain at the lower portion thereof due to slow expansion.

In the electrode including the active material layer having the surface from which the projections are removed without storing the lithium as with the conventional methods, the heights of the columnar active materials on the electrode are substantially uniform. Therefore, as the active material expands by charging, gaps among the columns are filled, so that the electrolytic solution does not reach the lower portion of the active material layer. Further, as described above, the lithium is stored sequentially from the upper portions of the columns during charging. Therefore, as the charging proceeds, gaps among the columns at the upper portions of the columns are filled, and the electrolytic solution cannot get in and out of the gaps. On this account, in a case where the charging further proceeds in a state where the electrolytic solution cannot flow to anywhere, and the middle and lower portions of the columnar active material layer expands, the electrolytic solution which cannot flow to anywhere is compressed, and this generates high pressure. This may cause the peel-off of the active material layer from the current collector and the decrease in strength of the active material layer.

In contrast, in the electrode from which the projections are removed after the lithium is stored by the producing method of the present invention, the columnar active material includes regions which do not store the lithium after the second step and expand little. Therefore, even when the active material layer in the region which has stored the lithium in the second step further expands by charging to fill the gaps among the columns, gaps among the columns in the region which did not store the lithium in the second step are easily maintained, and therefore, the electrolytic solution can flow to the lower portion of the active material layer. Further, since the electrolytic solution remaining at the lower portion of the columnar active material layer can get in and out through these gaps, the generation of the pressure by the expansion of the active material layer can be suppressed.

A third aspect of the present invention is an electrochemical element including: a negative electrode constituted by the electrode according to the second aspect of the present invention; a positive electrode including a sheet-shaped positive-electrode current collector and a positive-electrode active material layer disposed on the positive-electrode current collector, the positive-electrode active material layer being provided to be opposed to the active material layer of the negative electrode; and a separator provided between the negative electrode and the positive electrode. The positive-electrode active material layer emits lithium ions during charging and stores, during discharging, lithium ions emitted from the negative-electrode active material layer. The negative-electrode active material layer stores, during charging, lithium ions emitted from the positive-electrode active material layer and emits lithium ions during discharging.

In this electrochemical element, the active material layer of the negative electrode includes an opposed region which is opposed to the positive-electrode active material layer in a thickness direction of the separator and a non-opposed region which is not opposed to the positive-electrode active material layer in the thickness direction. This is to prevent the short-circuit from occurring by the deposition of a lithium metal on positive-electrode active material layer during charging.

In the electrochemical element of the present invention, the active material layer of the negative electrode stores the lithium, and the minute regions which do not store the lithium exist on the surface of the active material layer of the negative electrode. However, by repeatedly charging and discharging the electrochemical element, the lithium is stored in and emitted from the minute regions. As a result, it becomes difficult to distinguish the minute region and the peripheral region around the minute region.

However, since the above-described non-opposed region is not opposed to the positive-electrode active material layer, storing and emitting of the lithium by charging and discharging do not occur in the non-opposed region. Therefore, even after the electrochemical element is repeatedly charged and discharged, the minute regions which do not store the lithium are maintained in the non-opposed region. Thus, it is easy to distinguish the minute region and the peripheral region which stores the lithium. On this account, in the electrochemical element of the present invention, it is preferable to confirm the existence of the minute region on the surface of the active material layer in the non-opposed region.

Examples of the electrochemical element of the present invention are lithium secondary batteries and electrochemical capacitors.

### Advantageous Effects of Invention

In accordance with the electrochemical element electrode producing method of the present invention, the projections that are the splash particles existing on the surface of the active material layer store the lithium to expand in the second step of storing the lithium in the active material layer, and thus, the projections can be easily and surely removed in the third step.

In accordance with the electrochemical element electrode of the present invention, the projections that are the splash particles formed by the vacuum deposition are removed. Therefore, when stacking the electrode and the separator to produce a battery or capacitor, the possibility of the internal short-circuit by the penetration of the separator by the projections can be avoided.

In accordance with the electrochemical element of the present invention, the projections that are the splash particles formed by the vacuum deposition are removed from the negative electrode. Therefore, the possibility of the internal short-circuit by the penetration of the separator by the projections can be avoided.

### BRIEF DESCRIPTION OF DRAWINGS

FIG. 1 is a schematic diagram showing one example of a device used in a first step of an embodiment of the present invention.

FIG. 2 is a schematic diagram showing one example of a device used in a second step of the embodiment of the present invention.

FIG. 3 is a schematic diagram showing another example of the device used in the second step of the embodiment of the present invention.

FIG. 4 is a schematic diagram showing one example of a device used in a third step of the embodiment of the present invention.

FIG. 5 is a schematic cross-sectional view of a lithium secondary battery in the embodiment of the present invention.

FIG. 6 is a schematic cross-sectional view of an electrochemical capacitor in the embodiment of the present invention.

FIG. 7 is a flow chart showing respective steps of a producing method of the present invention.

FIG. 8 is a schematic top view showing a state where a positive-electrode active material layer 55 and a negative-electrode active material layer 58 shown in FIG. 5 are stacked.

### DESCRIPTION OF EMBODIMENTS

Hereinafter, an embodiment of the present invention will be explained in reference to the drawings.

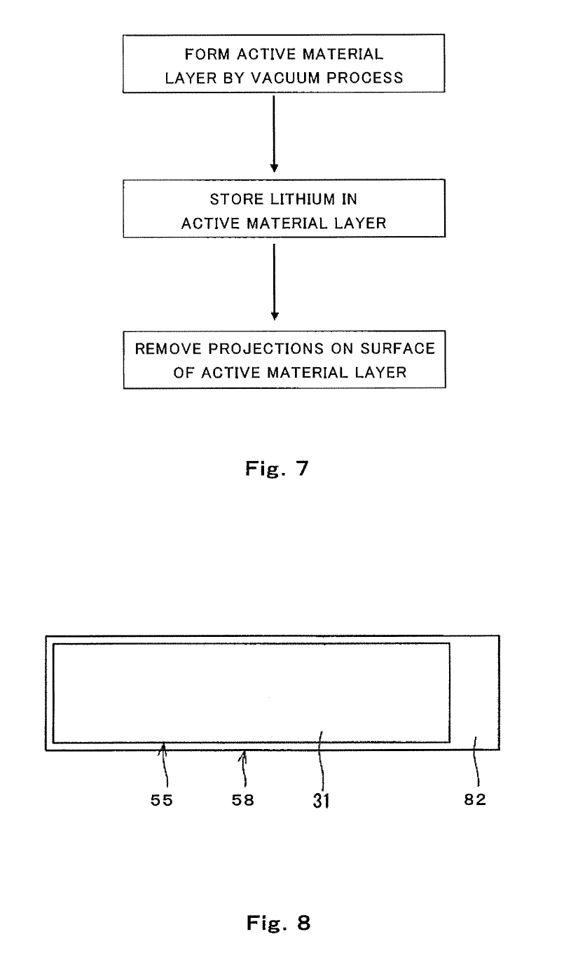

FIG. 7 is a flow chart showing respective steps of a producing method of the present invention. In the producing method of the present invention, first, a first step is carried out, in which an active material layer capable of storing and emitting lithium is formed on a current collector by a vacuum process. Next, a second step is carried out, in which lithium is stored in the active material layer. Further, a third step is carried out, in which projections on the surface of the active material layer which has stored the lithium are removed. Hereinafter, details of respective steps will be explained.

First Step

In the first step of the present invention, the active material layer is formed on the surface of the current collector in vacuum by a deposition method.

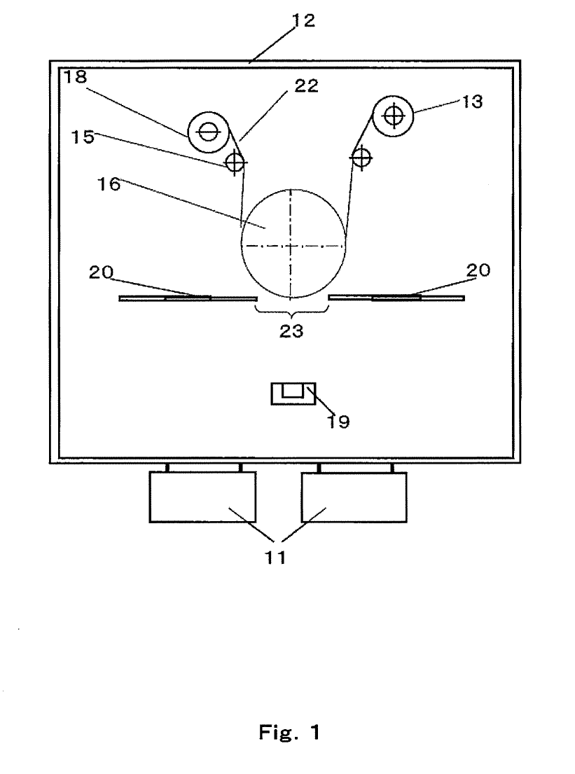

FIG. 1 is a schematic diagram showing one example of a device used in the first step of an electrochemical element electrode producing method of the present invention. A vacuum container (12) is maintained in a reduced-pressure state by an exhaust device (11). In the vacuum container (12), a thin film formation source (19) and a substrate feed system are provided. The substrate feed system includes a pull-out roller (18) for a substrate, a feed roller (15), a take-up roller (13) for the substrate, and the like.

The thin film formation source (19) is configured such that a thin film raw material is put in a container. To obtain a high thin film formation speed, the thin film formation source (19) carries out heating by irradiation of electrons from an electron ray source (not shown). A cooling can (16) and a shielding plate (20) having an opening are arranged above the thin film formation source. The thin film formation source and the substrate on the cooling can are opposed to each other via the opening.

A substrate (22) that is a current collector travels along the opening of the shielding plate (20) while it is pulled out from the pull-out roller (18), travels along the feed roller (15), and is taken up by the take-up roller (13).

The substrate (22) is a band-shaped elongated substrate, and a material thereof is not especially limited. Examples are various metal foils, such as aluminum foils, copper foils, nickel foils, titanium foils, and stainless steel foils, various polymer films, such as polyethylene terephthalate, polyethylene naphthalate, polyamide, and polyimide, and a complex of a polymer film and a metal foil.

While the substrate (22) travels along the opening of the shielding plate, a part of particles flying from the thin film formation source (19) arranged under the shielding plate move through the opening to be adhered to the substrate (22) in a thin film forming portion (23), thereby forming the active material layer.

Each of the pull-out roller (18) and the take-up roller (13) can control the rotation thereof. Therefore, tension is applied to the substrate (22) on the cooling can. A part of the feed system, such as a drive motor, may be arranged outside the vacuum container (12), and driving force may be transmitted through a rotation transmitting terminal into the vacuum container (12).

Moreover, for the purpose of changing the property of the active material layer, reactive deposition may be carried out by introducing an oxygen gas to the thin film forming portion (23) during the thin film formation.

Moreover, for the purpose of changing the property of the active material layer, the active material layer formed by a plurality of columnar active material particles arranged on the surface of the substrate may be formed by, for example, a method using a substrate having a surface on which projections and depressions are formed.

Moreover, the active material layer may be formed on each of both surfaces of the substrate by a method for forming the active material layer by the first step, turning over the substrate, and repeating the first step again.

In this step, splash particles are adhered to the surface of the active material layer by the bumping in the vacuum deposition.

Second Step

In the second step of the present invention, lithium is stored in the active material layer which has been formed on the surface of the current collector in the first step. The following two methods are suitably used for this step. A first method is a method for storing the lithium in the active material layer in vacuum, and a second method is a method for immersing the current collector having a surface, on which the active material layer is formed, in an electrolytic solution to electrochemically store the lithium in the active material layer. It is desirable that the amount of lithium stored in the active material layer by these methods be 10% or higher of a theoretical charging capacity calculated from the weight of an active material of a polar plate. It is further desirable that the amount of lithium be 20% or higher of the theoretical charging capacity. With this, the projections can be successfully peeled off and removed from the polar plate in the third step.

As the first method for storing lithium in vacuum, a deposition method or sputtering may be used. In these method, since a straight moving property of lithium particles is high, it is difficult to diffuse lithium to the active material layer hidden under the projections, and a difference between an expansion coefficient of the projection and an expansion coefficient of the active material layer tends to become large. Therefore, performance of removing the projections is excellent. Moreover, it is easy to control the amount of lithium stored. In the second method for electrochemically storing the lithium, it is advantageous in that even if the amount of lithium stored is large, the lithium is unlikely to be deposited on the surface of the polar plate.

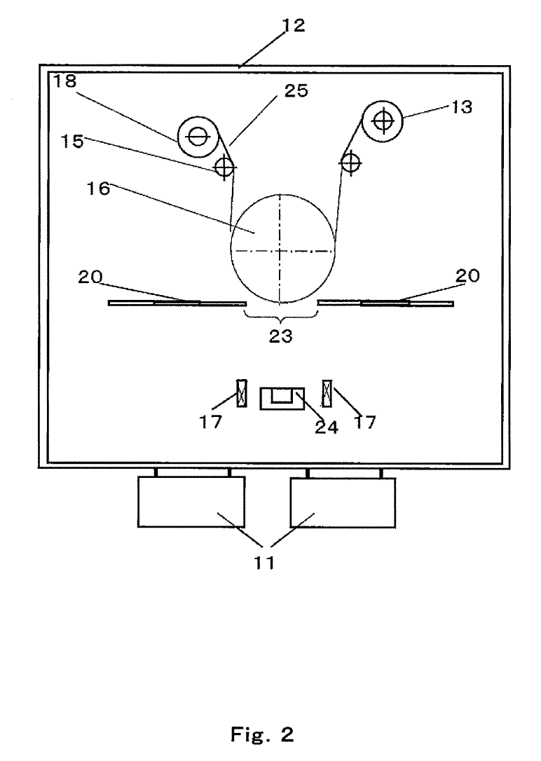

FIG. 2 is a schematic diagram showing one example of a device which can be used in the second step in the electrochemical element electrode producing method of the present invention and stores the lithium in the active material layer in vacuum by the deposition method.

The vacuum container (12) is maintained in a reduced-pressure state by the exhaust device (11). In the vacuum container (12), a lithium source (24) and a polar plate feed system are arranged. The polar plate feed system includes the pull-out roller (18) for the polar plate, the feed roller (15), the take-up roller (13) for the polar plate, and the like.

The lithium source (24) is configured such that lithium is put in a container and heated by, for example, a resistance heater (17). The cooling can (16) is arranged above the lithium source and opposed to the lithium source via the shielding plate (20) having the opening.

A polar plate (25) that is a current collector having a surface on which the active material layer is formed travels along the opening of the shielding plate while it is pulled out from the pull-out roller (18), travels along the feed roller (15), and is taken up by the take-up roller (13).

While the polar plate (25) travels along the opening of the shielding plate, a part of the lithium particles flying from the lithium source (24) arranged under the shielding plate move through the opening to be adhered to the active material layer on the polar plate (25) at a lithium storing portion (23). Thus, the lithium is stored in the active material layer.

Each of the pull-out roller (18) and the take-up roller (13) can control the rotation thereof. Therefore, tension is applied to the polar plate (25) such that the polar plate uniformly spreads on the cooling can (16). A part of the feed system, such as a drive motor, may be arranged outside the vacuum container (12), and driving force may be transmitted through the rotation transmitting terminal into the vacuum container (12).

The amount of lithium stored is adjustable by the heating temperature of the lithium source and the travelling speed of the polar plate.

FIG. 3 is a schematic diagram showing one example of a device which can be used in the second step of the electrochemical element electrode producing method of the present invention and electrochemically stores lithium in an electrolytic solution.

A lithium counter electrode (31), an electrolytic solution (32), and the polar plate feed system are put in an electrolytic solution container (30). The polar plate feed system includes the pull-out roller (18) for the polar plate, the feed roller (15), the can (16) for electrolysis, the take-up roller (13) for the polar plate, and the like.

Each of the pull-out roller (18) and the take-up roller (13) can control the rotation thereof. Therefore, tension is applied to the polar plate (25) such that the polar plate uniformly spreads on the cooling can (16).

A part of the can (16) is immersed in the electrolytic solution (32), and the lithium counter electrode (31) is held in the electrolytic solution. There is a potential difference between the polar plate (25) and the lithium counter electrode. By this potential difference, the lithium moves from the lithium counter electrode (31) through the electrolytic solution to be stored in the active material layer of the polar plate (25) on the can.

As a method for giving a potential to the polar plate, it is possible to adopt a method for giving a potential to the can (16) to give a potential to the polar plate (25) which is travelling while contacting the can (16) or a method for giving a potential to each of the feed roller (15), the take-up roller (13), and the pull-out roller (18) to give a potential to the polar plate (25).

As the electrolytic solution, various nonaqueous electrolytic solutions having lithium ion conductivity may be used. The nonaqueous electrolytic solution prepared by dissolving a lithium salt (such as lithium hexafluorophosphate) in a nonaqueous solvent (such as ethylene carbonate or ethyl methyl carbonate) may be preferably used. The composition of the nonaqueous electrolytic solution is not especially limited.

The polar plate (25) travels along the can (16) while it is pulled out from the pull-out roller (18), moves along the feed roller (15), and is taken up by the take-up roller (13).

The amount of lithium stored is adjustable by the applied voltage and the travelling speed of the polar plate.

In the present invention, the lithium can be stored in both surfaces of the polar plate having the surfaces on which the active material layers are respectively formed by a method for forming the active material layer by the second step, turning over the polar plate, and repeating the second step.

Third Step

The third step of the present invention is a step of removing the projections existing on the surface of the active material layer which has stored the lithium in the second step. This removing step may be carried out under a reduced-pressure atmosphere or a normal-pressure atmosphere. Moreover, this step can be carried out in a liquid.

A specific method for carrying out the third step of the present invention is not especially limited. However, examples of the method are a method for removing the projections on the surface of the active material layer by causing a removing means to physically contact the projections and a method for removing the projections on the surface of the active material layer without causing the removing means to directly contact the projections. Examples of the former method are a method for wiping the surface of the active material layer with a wiping cloth, a method for covering the surface of the active material layer with an adhesive tape and peeling off the adhesive tape from the surface of the active material layer, and a method for removing the projections by using a cutter having a linear cutting edge, such as a blade, and moving the active material layer with the linear cutting edge maintained at a predetermined distance from the surface of the active material layer. Examples of the latter method are a method for removing the projections by air blow and a method for irradiating the surface of the active material layer with ultrasound in a liquid.

In a case where the second step is carried out in vacuum and the third step is carried out under a reduced-pressure atmosphere, the third step can be carried out in the device used in the second step. Moreover, in a case where the second step is carried out in the electrolytic solution and the third step is carried out by the wiping cloth, the blade, the ultrasound irradiation, or the like, the third step can be carried out in a lithium storing device used in the second step in the electrolytic solution.

The electrochemical element electrode produced as above can be used as a negative electrode of an electrochemical element, such as a lithium secondary battery or an electrochemical capacitor.

Lithium Secondary Battery

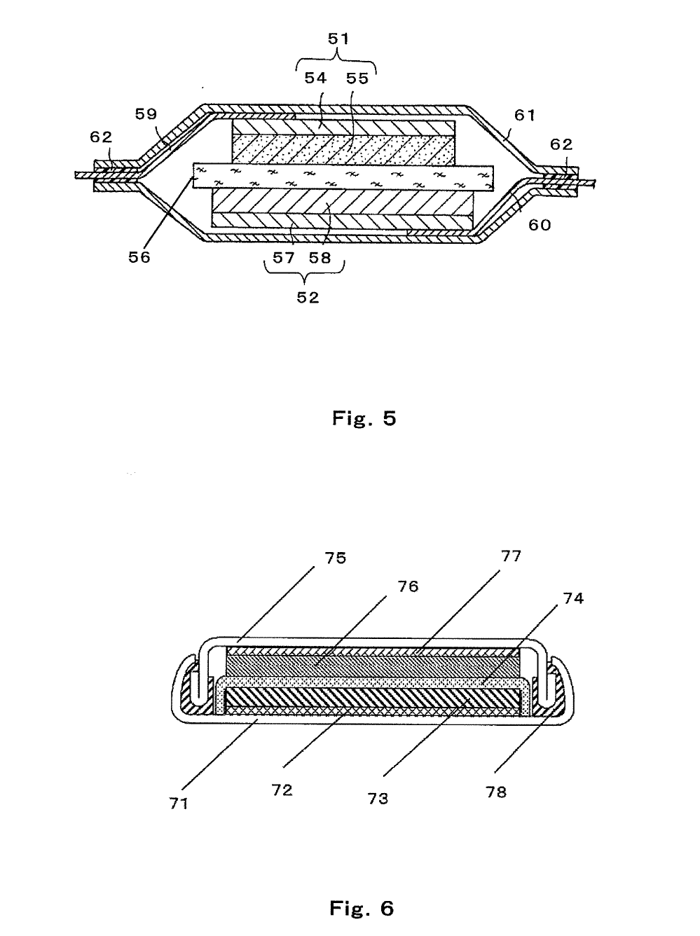

FIG. 5 is a schematic cross-sectional view of a lithium secondary battery in the embodiment of the present invention.

The lithium secondary battery includes an electrode group. The electrode group includes a positive electrode 51, a negative electrode 52, and a separator 56 disposed between the electrodes 51 and 52. The electrode group and an electrolyte having lithium ion conductivity are accommodated in an aluminum-laminated sealed container 61. The positive electrode 51 is constituted by a sheet-shaped positive-electrode current collector 54 and a positive-electrode active material layer 55 disposed on the positive-electrode current collector 54. The negative electrode 52 is constituted by a sheet-shaped negative-electrode current collector 57 and a negative-electrode active material layer 58 disposed on the negative-electrode current collector 57. The positive-electrode active material layer 55 and the negative-electrode active material layer 58 are opposed to each other via the separator 56. One end of a positive-electrode lead 59 is connected to the positive-electrode current collector 54, and one end of a negative-electrode lead 60 is connected to the negative-electrode current collector 57. The other ends of the leads 59 and 60 extend to the outside of the sealed container 61. Openings of the sealed container 61 are sealed by resin materials 62.

FIG. 5 shows a structure including a pair of the positive electrode 51 and the negative electrode 52. However, the present invention is not limited to this structure. For example, the positive-electrode active material layers 55 may be respectively disposed on both surfaces of the positive-electrode current collector 54, this positive electrode may be sandwiched between two separators, and two negative electrodes may be respectively disposed on the two separators. In this case, the positions of the negative electrode and the positive electrode are interchangeable.

FIG. 8 is a schematic top view showing a state where the positive-electrode active material layer 55 and the negative-electrode active material layer 58 shown in FIG. 5 are stacked, when viewed from above the positive-electrode active material layer 55. In FIG. 8, the separator 56 disposed between the positive-electrode active material layer 55 and the negative-electrode active material layer 58 is omitted. As shown in FIG. 8, when viewed from above the positive-electrode active material layer 55 (to be specific, when viewed from a thickness direction of the separator), the negative-electrode active material layer 58 is larger than the positive-electrode active material layer 55, and the negative-electrode active material layer 58 is divided into two regions that are an opposed region 81 which is opposed to the positive-electrode active material layer 55 and a non-opposed region 82 which is not opposed to the positive-electrode active material layer 55.

The foregoing has explained a stacked battery as one example. However, as the structure of the lithium secondary battery of the present invention, it is possible to suitably adopt a cylindrical battery including a rolled polar plate group or a square battery.

Since a feature of the present invention is the configuration of the negative electrode, components other than the negative electrode in the lithium secondary battery are not especially limited. For example, a lithium-containing transition metal oxide, such as lithium cobalt oxide (LiCoO₂), lithium nickel oxide (LiNiO₂), or lithium manganese oxide (LiMn₂O₄), can be used as a positive-electrode active material. However, the present invention is not limited to this. Moreover, the positive-electrode active material layer may be constituted only by the positive electrode active material or by a combination of the positive electrode active material, a binding agent, and an electrically-conductive agent. As the positive-electrode current collector, Al, an Al alloy, Ti, or the like may be used.

As the separator, a separator commonly used in the lithium ion secondary battery can be used. One example is porous polypropylene. The present invention is not limited by the separator.

As the electrolyte having the lithium ion conductivity, various solid electrolytes and nonaqueous electrolytic solutions having the lithium ion conductivity may be used. The nonaqueous electrolytic solution prepared by dissolving a lithium salt in a nonaqueous solvent is preferably used. The composition of the nonaqueous electrolytic solution is not especially limited.

The separator and an exterior case are not especially limited, and various materials used in the lithium secondary batteries can be used without limit.

Method for Producing Capacitor

FIG. 6 is a schematic cross-sectional view of an electrochemical capacitor in the embodiment of the present invention. The electrochemical capacitor includes a positive-electrode active material layer 73, a positive-electrode current collector 72, a negative-electrode active material layer 76, a negative-electrode current collector 77, a separator 74, a sealing plate 75, a gasket 78, and a case 71.

An electrode body is formed such that the positive-electrode active material layer and the negative-electrode active material layer are disposed to be opposed to each other via the separator impregnated with the nonaqueous electrolytic solution. Since a feature of the present invention is the configuration of the negative electrode, a positive-electrode material, such as activated carbon, commonly used in electrochemical capacitors can be used as the positive electrode active material. The present invention is not limited by the positive electrode. The nonaqueous electrolytic solution prepared by dissolving a lithium salt in a nonaqueous solvent is preferably used. The composition of the nonaqueous electrolytic solution is not especially limited.

### Example

Hereinafter, the present invention will be explained in more details by using Example. However, the present invention is not limited to Example below.

First, for the purpose of forming a negative electrode polar plate of a nonaqueous electrolyte secondary battery, the first step was carried out to form a Si thin film on a negative-electrode current collector.

To be specific, in the configuration of the device shown in FIG. 1, a roughened copper foil (EXP-DT-NC, 35 μm, produced by Furukawa Circuit Foil Co., Ltd.) having a width of 28 cm was used as the substrate, and the position of the shielding plate was adjusted such that the length of the thin film forming portion (23) was set to about 45 cm. The thin film formation source (19) that was a graphite crucible in which highly-pure Si (99.9% pure) was put was placed such that a shortest distance between the thin film formation source (19) and the thin film forming portion (23) was set to 40 cm. The thin film formation was carried out as follows: Si was heated and dissolved by an electron ray under a reduced-pressure condition of about 10⁻² Pa; the surface temperature of Si melt was maintained at about 2,000° C.; and the substrate travelled at about 0.33 meter per minute while applying tension of 5 kgf to the substrate.

The obtained polar plate was observed with a laser microscope. About 20 to 50 projections per square centimeter were observed on the polar plate, the projections having particle diameters of about 5 to 500 μm.

Without carrying out the second step of the present invention, the surface of the active material of the polar plate was wiped with a wiping cloth (GC10000 produced by Nihon Micro Coating Co., Ltd.). Moreover, the surface of the active material of the polar plate was covered with an adhesive tape (650S #50 produced by Teraoka Seisakusho Co., Ltd.), and the adhesive tape was peeled off. However, the projections were not removed.

Moreover, a part of the polar plate was punched to obtain a circular plate having a diameter of 12.5 mm. With the circular plate immersed in the electrolytic solution, the circular plate was subjected to an ultrasonic process for one minute or longer by an ultrasonic processor (SUS-100PN produced by Shimadzu Corporation, Vibrational Frequency of 28 kHz and Output of 100 W). However, the projections were not removed by this method.

Next, the second step of the present invention using the vacuum deposition was carried out with respect to the polar plate obtained in the first step.

To be specific, in the configuration of the device shown in FIG. 2, the polar plate obtained in the first step was used, and the position of the polar plate was adjusted such that a distance from the lithium source (24), which was a crucible in which lithium was put, to the polar plate was set to 10 cm. The crucible was heated to 600° C. by resistance heating under a reduced-pressure condition of about 10⁻² Pa to deposit the lithium on the active material layer. By adjusting the deposition time, three types of polar plates were formed such that their amounts of lithium stored were respectively 10%, 20%, and 30% of the theoretical charging capacity of the active material layer.

The theoretical charging capacity of the active material layer was calculated by the following method. First, the weight of the active material per unit area was calculated by subtracting the premeasured weight of the roughened copper foil per unit area from the weight of the polar plate per unit area. Next, the theoretical charging capacity of the active material layer was calculated by multiplying the theoretical charging capacity of the active material per unit weight and the actually-measured weight of the active material.

Each of the surfaces of the active material layers of the three types of polar plates which had been subjected to the second step was wiped again with the wiping cloth (GC10000 produced by Nihon Micro Coating Co., Ltd.). As a result, the projections were successfully removed from these polar plates formed such that their amounts of lithium stored were respectively 10%, 20%, and 30%.

Similarly, each of the surfaces of the active material layers of the polar plates which had been subjected to the second step was covered with the adhesive tape (650S #50 produced by Teraoka Seisakusho Co., Ltd.), and the adhesive tape was peeled off. As a result, the projections were successfully removed from these polar plates formed such that their amounts of lithium stored were respectively 10%, 20%, and 30%.

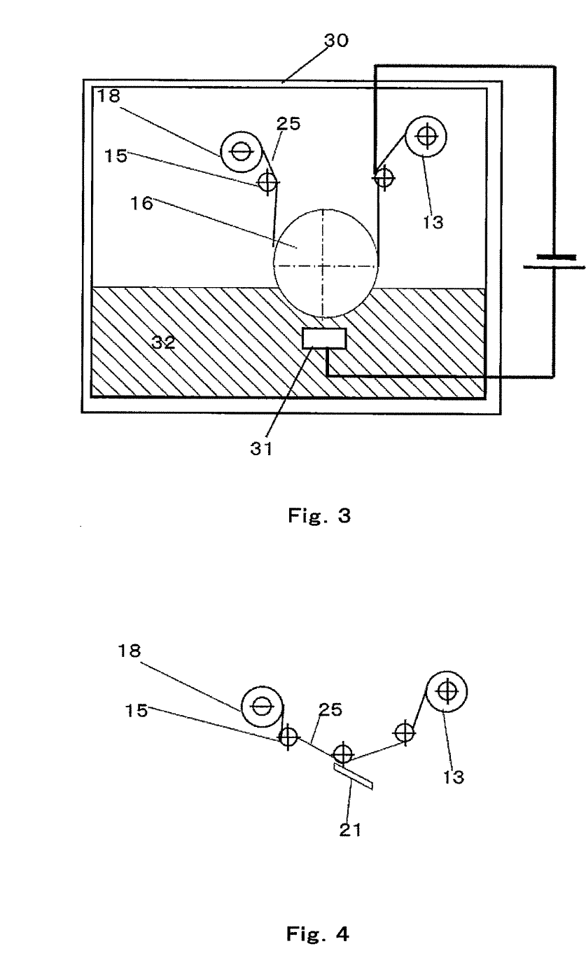

Moreover, as shown in FIG. 4, the polar plate (25) was placed in a polar plate travel system including the pull-out roller (18), the take-up roller (13), and the feed roller (15), and a linear cutter (21) having a width of 10 mm and a cutting edge flatness of 1 μm or less was placed at a position 20 μm away from the surface of the active material layer. In this state, the polar plates each including the active material layer having the surface on which the projections were formed were moved. As a result, the projections were successfully peeled off and removed from these polar plates formed such that their amounts of lithium stored were respectively 10%, 20%, and 30%.

The polar plate which had been subjected to the second step was punched to obtain a circular plate having a diameter of 12.5 mm. With the circular plate immersed in the electrolytic solution, the circular plate was irradiated with ultrasound for ten seconds by the ultrasonic processor (SUS-100PN produced by Shimadzu Corporation, Vibrational Frequency of 28 kHz and Output of 100 W). As a result, as with the other methods, the projections were peeled off and removed from these polar plates formed such that their amounts of lithium stored were respectively 10%, 20%, and 30%.

Next, a sample which had been subjected to the second step using an electrochemical method was prepared. In accordance with this method, the lithium is comparatively unlikely to be deposited on the surface of the active material layer.

To be specific, in the configuration of the device shown in FIG. 3, the polar plate obtained in the first step was used, the lithium counter electrode was opposed to the polar plate in the electrolytic solution (ethylene carbonate (EC):ethyl methyl carbonate (EMC):diethyl carbonate (DEC)=3:5:2 (volume ratio), 1M LiPF₆ (produced by Mitsubishi Chemical Corporation)), and the potential difference between the lithium counter electrode and the polar plate was generated. With this, the lithium was stored in the active material layer. Three types of polar plates were formed such that their amounts of lithium stored were respectively adjusted to 10%, 50%, and 100% of the theoretical charging capacity of the active material layer.

The theoretical charging capacity of the polar plate was calculated by the above-described method.

Each of the surfaces of the active material layers of the three types of polar plates which had been subjected to the second step was wiped again with the wiping cloth (GC10000 produced by Nihon Micro Coating Co., Ltd.). As a result, the projections were successfully removed from these polar plates formed such that their amounts of lithium stored were respectively 10%, 50%, and 100%.

Similarly, each of the surfaces of the active material layers of the polar plates which had been subjected to the second step was covered with the adhesive tape (650S #50 produced by Teraoka Seisakusho Co., Ltd.), and the adhesive tape was peeled off. As a result, the projections were successfully removed from these polar plates formed such that their amounts of lithium stored were respectively 10%, 50%, and 100%.

Moreover, as shown in FIG. 4, the polar plate (25) was placed in the polar plate travel system including the pull-out roller (18), the take-up roller (13), and the feed roller (15), and the linear cutter (21) having a width of 10 mm and a cutting edge flatness of 1 μm or less was placed at a position 20 μm away from the surface of the active material layer. In this state, the polar plates each including the active material layer having the surface on which the projections were formed were moved. As a result, the projections were successfully removed from these polar plates formed such that their amounts of lithium stored were respectively 10%, 50%, and 100%.

The polar plate which had been subjected to the second step was punched to obtain a circular plate having a diameter of 12.5 mm. With the circular plate immersed in the electrolytic solution, the circular plate was irradiated with ultrasound for ten seconds by the ultrasonic processor (SUS-100PN produced by Shimadzu Corporation, Vibrational Frequency of 28 kHz and Output of 100 W). As a result, as with the other methods, the projections were peeled off and removed from these polar plates formed such that their amounts of lithium stored were respectively 10%, 50%, and 100%.

Instead of the 99.9% pure Si, 99.99% pure Si which was higher in purity was used as the thin film raw material, and the thin film formation was carried out in accordance with the same procedure as above. The obtained polar plate was observed with the laser microscope. About 1 to 20 projections per square centimeter were observed on the polar plate, the projections having the particle diameters of about 5 to 500 μm. Further, by the same method as above, the lithium was deposited on the active material layer, and three types of polar plates were formed such that their amounts of lithium stored were respectively adjusted to 10%, 20%, and 30% of the theoretical charging capacity of the active material layer. Each of the surfaces of the active material layers of these three types of polar plates was wiped with the wiping cloth (GC10000 produced by Nihon Micro Coating Co., Ltd.). As a result, the projections were successfully removed from these polar plates.

The surface of the active material layer of the polar plate from which the projections were peeled off and removed in the above Example was subjected to the analysis of element distribution by fluorescent X-ray microanalysis. Thus, the number of minute regions which did not store the lithium and the average diameter of the minute regions were calculated. Specifically, a polar plate sample was exposed to the atmosphere having the dew point of −20° C. to oxidize the lithium on the surface of the polar plate, and the oxidized lithium was detected by the element analysis. Thus, the number of minute regions, each having a diameter of 1 μm or more, per square centimeter and the diameters of the respective minute regions were measured. An arithmetic average of the obtained diameter values was regarded as the average diameter. Results of the measurement are shown in Tables 1, 2, and 3 below. As a simplified method, any portion of 1 cm² on the surface of the active material layer was observed with the laser microscope, the number of minute regions each having a diameter of 1 μm or more within a monitor was counted, the diameters of the respective regions were measured, and thus, the average diameter was obtained.

TABLE 1

| | | Second Step Using Vacuum Deposition | | | | | |
|---|---|---|---|---|---|---|---|
| | | Amount of Lithium Stored (%) | | | | | |
| | | 10 | | 20 | | 30 | |
| | | Minute Region | | | | | |
| | | Average | | Average | | Average | |
| | | Diameter | | Diameter | | Diameter | |
| | | (μm) | Number | (μm) | Number | (μm) | Number |
| Removing | Wiping | 79 | 29 | 61 | 47 | 261 | 32 |
| Means | Cloth | | | | | | |
| | Adhesive | 63 | 23 | 171 | 27 | 320 | 37 |
| | Tape | | | | | | |
| | Cutter | 420 | 42 | 84 | 34 | 91 | 28 |
| | Ultrasound | 280 | 43 | 45 | 33 | 80 | 45 |

TABLE 2

| | | Second Step Using Electrochemical Method | | | | | |
|---|---|---|---|---|---|---|---|
| | | Amount of Lithium Stored (%) | | | | | |
| | | 10 | | 50 | | 100 | |
| | | Minute Region | | | | | |
| | | Average | | Average | | Average | |
| | | Diameter | | Diameter | | Diameter | |
| | | (μm) | Number | (μm) | Number | (μm) | Number |
| Removing | Wiping | 55 | 39 | 158 | 24 | 47 | 41 |
| Means | Cloth | | | | | | |
| | Adhesive | 146 | 38 | 48 | 40 | 23 | 21 |
| | Tape | | | | | | |
| | Cutter | 203 | 26 | 419 | 30 | 67 | 25 |
| | Ultrasound | 63 | 28 | 255 | 47 | 166 | 29 |

TABLE 3

| | | Second Step Using Vacuum Deposition | | | | | |
|---|---|---|---|---|---|---|---|
| | | Amount of Lithium Stored (%) | | | | | |
| | | 10 | | 20 | | 30 | |
| | | Minute Region | | | | | |
| | | Average | | Average | | Average | |
| | | Diameter | | Diameter | | Diameter | |
| | | (μm) | Number | (μm) | Number | (μm) | Number |
| Removing | Wiping | 18 | 2 | 14 | 8 | 21 | 15 |
| Means | Cloth | | | | | | |

### INDUSTRIAL APPLICABILITY

In accordance with the electrochemical element electrode producing method of the present invention, it is possible to remove the projections formed on the polar plate when the active material layer is formed by the vacuum process. The producing method of the present invention is useful as a method for producing electrodes for electrochemical elements, such as lithium ion batteries and electrochemical capacitors. In accordance with the electrochemical element electrode and electrochemical element of the present invention, the possibility of the internal short-circuit caused due to the penetration of the separator can be reduced.

### REFERENCE SIGNS LIST

11 exhaust device
12 vacuum container
13 take-up roll
15 feed roller
16 can
17 heater
18 pull-out roll
19 thin film formation source
20 shielding plate
21 cutter
22 substrate
23 thin film forming portion
24 lithium source
25 polar plate
30 electrolytic solution container
31 lithium counter electrode
32 electrolytic solution
54 positive-electrode current collector
55 positive-electrode active material layer
56 separator
57 negative-electrode current collector
58 negative-electrode active material layer
59 positive-electrode lead
60 negative-electrode lead
61 sealed container
71 case
72 positive-electrode current collector
73 positive-electrode active material layer
74 separator
75 sealing plate
76 negative-electrode current collector
77 negative-electrode active material layer
78 gasket

1. A method for producing an electrochemical element electrode, comprising:
a first step of forming an active material layer on a current collector by a vacuum process, the active material layer being capable of storing and emitting lithium;
a second step of storing the lithium in the active material layer; and
a third step of removing projections on a surface of the active material layer storing the lithium.

2. The method according to claim 1, wherein the active material is formed by silicon, a silicon oxide, an alloy containing silicon, or a compound containing silicon.

3. The method according to claim 1, wherein the amount of lithium stored in the second step of storing the lithium is not lower than 10% and not higher than 100% of a theoretical charging capacity of the active material layer.

4. The method according to claim 1, wherein the second step of storing the lithium is a step of storing the lithium in the active material layer by a vacuum process.

5. The method according to claim 1, wherein the second step of storing the lithium is a step of storing the lithium in the active material layer by an electrochemical process.

6. The method according to claim 1, wherein the third step of removing the projections is a step of causing a removing means to physically contact the projections on the surface of the active material layer to remove the projections.

7. The method according to claim 6, wherein the third step of removing the projections is a step of wiping the surface of the active material layer with a wiping cloth.

8. The method according to claim 6, wherein the third step of removing the projections is a step of covering the surface of the active material layer with an adhesive tape and peeling off the adhesive tape from the surface of the active material layer.

9. The method according to claim 6, wherein the third step of removing the projections is a step of removing the projections by using a cutter having a linear cutting edge and moving the active material layer with the linear cutting edge maintained at a predetermined distance from the surface of the active material layer.

10. The method according to claim 1, wherein the third step of removing the projections is a step of removing the projections on the surface of the active material layer without causing a removing means to directly contact the projections.

11. The method according to claim 10, wherein the third step of removing the projections is a step of irradiating the surface of the active material layer with ultrasound in a liquid.

12. An electrochemical element electrode comprising:
a sheet-shaped current collector; and
an active material layer supported by the current collector, wherein:
the active material layer stores lithium, the amount of which is not lower than 10% and not higher than 100% of a theoretical charging capacity of the active material layer; and
minute regions which do not store the lithium exist on a surface of the active material layer.

13. The electrochemical element electrode according to claim 12, wherein an average diameter of the minute regions is 10 to 500 μm.

14. The electrochemical element electrode according to claim 12, wherein 1 to 50 minute regions per square centimeter exist on the surface of the active material layer.

15. The electrochemical element electrode according to claim 12, wherein the active material layer is formed by silicon, a silicon oxide, an alloy containing silicon, or a compound containing silicon.

16. The electrochemical element electrode according to claim 12, wherein the active material layer is formed by arranging a plurality of columnar active materials on the current collector.

17. An electrochemical element comprising:
a negative electrode constituted by the electrode according to claim 12;
a positive electrode including a sheet-shaped positive-electrode current collector and a positive-electrode active material layer disposed on the positive-electrode current collector, the positive-electrode active material layer being provided to be opposed to the active material layer of the negative electrode; and
a separator provided between the negative electrode and the positive electrode.

18. The electrochemical element according to claim 17, wherein:
the active material layer of the negative electrode includes an opposed region which is opposed to the positive-electrode active material layer in a thickness direction of the separator and a non-opposed region which is not opposed to the positive-electrode active material layer in the thickness direction; and
the minute regions exist on the surface of the active material layer in the non-opposed region.

19. The electrochemical element according to claim 18, wherein 1 to 50 minute regions per square centimeter exist on the surface of the active material layer in the non-opposed region.

20. The electrochemical element according to claim 17, wherein an average diameter of the minute regions is 10 to 500 μm.

21. The electrochemical element according to claim 17, wherein the active material layer of the negative electrode is formed by silicon, a silicon oxide, an alloy containing silicon, or a compound containing silicon.

22. The electrochemical element according to claim 17, wherein the active material layer of the negative electrode is formed by arranging a plurality of columnar active materials on the current collector.

23. The electrochemical element according to claim 17, wherein the electrochemical element is a lithium secondary battery.

24. The electrochemical element according to claim 17, wherein the electrochemical element is an electrochemical capacitor.
